(19) United States
(12) Patent Application Publication
(10) Pub. No.: US 2009/0323458 A1
(43) Pub. Date: Dec. 31, 2009

(54) CONTINUOUS PROCESS FOR PERFORMING A CHEMICAL REACTION IN WHICH A GASEOUS PHASE IS ADDED TO A CHARGE SYSTEM COMPRISING ONE OR MORE SOLID PHASES WHICH HAVE BEEN DISSOLVED OR DISPERSED IN WATER

(76) Inventors: Wolfgang Fischer, Walldorf (DE); Chris Dearmitt, Hattiesburg, MS (US); Rainer Bardon, Dannstadt-Schauernheim (DE)

Correspondence Address: CONNOLLY BOVE LODGE & HUTZ, LLP, P O BOX 2207, WILMINGTON, DE, 19899, US

(21) Appl. No.: 12/296,951

(22) PCT Filed: Apr. 3, 2007
(86) PCT No.: PCT/EP07/53200

§ 371 Date: May 4, 2009

(30) Foreign Application Priority Data
Apr. 11, 2006 (EP) 0611482.2

(51) Int. Cl. B01F 13/02

(52) U.S. Cl. 366/105

(57) ABSTRACT

A chemical reaction is performed by first adding the incoming stream to a shear zone of an apparatus by way of a feed upstream of the shear zone. The apparatus includes a rotor and a stator, with the shear zone being formed by facing surfaces of the rotor and the stator. The shear zone is followed by a mixing zone having an outlet toward an outside of the apparatus. A gage pressure of at least 1 bar is generated in the shear zone. The gaseous phase is mixed into the mixing zone through the aperture and into the incoming stream under the generated gage pressure to create a reaction mixture. The reaction mixture is fed to a residence-time zone via a downstream outlet from the mixing zone, where a reaction takes place, and pressure in the mixing zone is controlled using a downstream pressure-control valve.

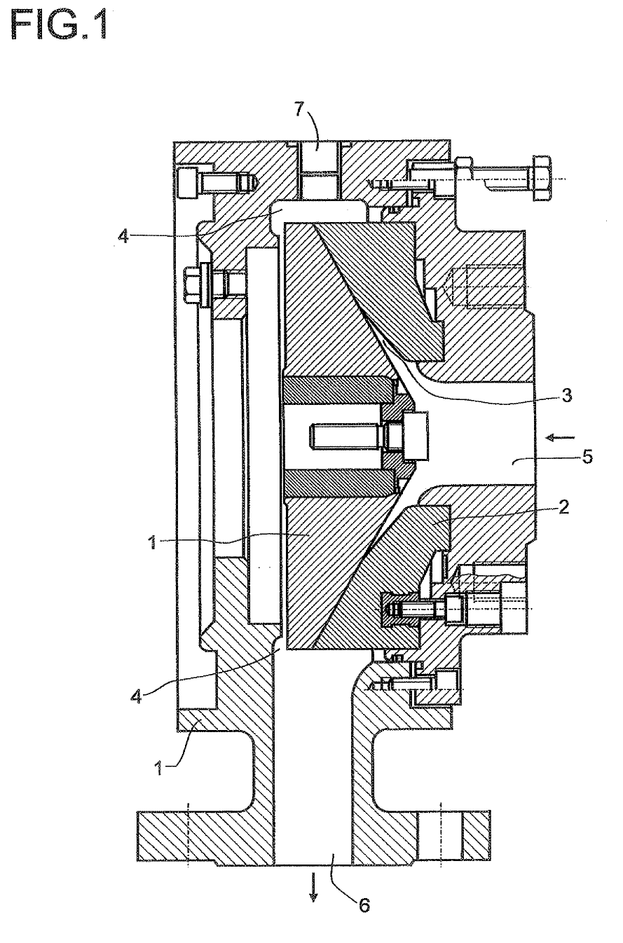

The invention relates to a continuous process for conduct of a chemical reaction in which a gaseous phase is added to an incoming stream comprising one or more solid phases dispersed or dissolved in water.

Numerous chemical reactions are based on the reaction of one or more solid phases dissolved or dispersed in water with a gaseous phase. The gaseous phase here has to be incorporated by mixing into the aqueous phase comprising one or more solid phases, in an ideal manner.

Numerous mixing apparatuses are known for continuous dispersion of solids in liquids, an example being the mixing apparatuses from IKA, Lipp Mischtechnik, or Buckau-Wolf. Many of the embodiments of the mixing apparatuses from those companies are not capable of generating pressures above 1 bar. This is achieved if required via downstream pumps, implying considerable additional technical cost.

For addition of gases in liquids, stirred tanks are often used, with specific gas inlet systems for bubbling to introduce the gases or with pipe systems in which there are static mixers downstream of the site of gas addition. In order to improve the solubility of the gases in the aqueous phase, operations have to be carried out under pressure, and this necessitates technically complicated solutions, in particular when solids have to be added at the same time.

In the light of this, it was an object of the invention to provide a simple industrial process which is intended for preparation of a reaction mixture, followed by a reaction, and in which a gaseous phase is added to an incoming stream comprising one or more solid phases dispersed or dissolved in water, ensuring excellent phase mixing.

The object is achieved via a continuous process for conduct of a chemical reaction in which a gaseous phase is added to an incoming stream comprising one or more solid phases dispersed or dissolved in water, which comprises

using a rotor/stator apparatus with a rotor and with a stator, where the surfaces turned toward one another of these form a shear zone, which is followed by a mixing zone with an aperture of the mixing zone toward the outside, and there is a feed upstream of the shear zone and an outlet downstream of the mixing zone,
adding the incoming stream comprising one or more solid phases dispersed or dissolved in water to the shear zone of the rotor/stator apparatus by way of the feed,
generating a gage pressure of at least 1 bar in the shear zone,
incorporating, by mixing, the gaseous phase into the mixing zone by way of its aperture toward the outside, and into the incoming stream, under the gage pressure generated in the shear zone of at least 1 bar or under a further-increased pressure, to give a reaction mixture, which is fed by way of the outlet to a residence-time zone in which the reaction takes place, and
downstream of which there is a pressure-control valve by way of which the pressure in the mixing zone is controlled.

Apparatuses that can generally be used for the inventive process are those where, in a shear zone, the incoming stream comprising one or more solid phases dispersed or dissolved in water can be brought to a gage pressure of at least 1 bar and, in a following mixing zone, under the gage pressure generated previously in the shear zone or under a further-increased pressure, a gaseous phase can be added, where the solubility of the gas in the liquid phase is markedly increased, and excellent mixing and short reaction times are achieved.

A rotor/stator apparatus as described for dispersion, distribution, and homogenization in DE 197 20 959 and known by the name Supraton® can advantageously be used: rotor and stator form a conical shearing gap between the mutually associated surfaces, with a gap width that can be adjusted via axial movement of rotor and/or stator, and this gap is followed by a annular space.

The apparatus has an axial feed pipe for feed of the mixture to be treated to the shearing gap and has a radial outlet pipe for dissipation of the same from the annular space.

Because the rotor and stator have conical geometry, gage pressures above 1 bar can be generated by way of this apparatus via the action of the pump.

This rotor/stator apparatus is advantageously utilized for production of mixtures, starting from an aqueous phase comprising one or more solid phases and from a gaseous phase, by utilizing the axial feed pipe as feed for the aqueous phase comprising one or more solid phases, and utilizing the aperture intended as discharge pipe in the annular space around rotor and stator toward the outside as the feed for the gaseous phase. In the annular space, the gaseous phase is homogeneously incorporated by mixing into the aqueous phase comprising one or more solid phases, under a gage pressure of at least 1 bar.

The incoming stream comprising one or more solid phases dispersed or dissolved in water can advantageously be fed to the axial feed pipe by way of a powder attachment on the ingoing side of the rotor/stator apparatus, for example the apparatus supplied as Vortex® from Buckau-Wolf.

Ideal incorporation by mixing of the gaseous phase into the incoming stream comprising one or more solid phases dispersed or dissolved in water takes place in that the material leaving the shearing gap is forced via the centrifugal forces into the annular gap into which the gas for incorporation by mixing is metered. The desired gage pressure in the annular space is set by way of a pressure-control valve downstream of the rotor/stator apparatus, thus markedly increasing the solubility of the gas in the liquid phase and thus permitting achievement of short reaction times.

The reaction mixture derived from the incoming stream and from the gaseous phase leaves the rotor/stator apparatus by way of the radial outlet pipe and enters a residence-time zone in which the chemical reaction takes place; the pressure-control valve is downstream of that zone.

In another preferred embodiment, the rotor/stator apparatus in which a gage pressure of at least 1 bar is generated in the incoming stream comprising one or more solid phases dispersed or dissolved in water can comprise a functional element which has a ring of teeth, preferably respectively on the rotor and on the stator, the shear zone being formed between the rings of teeth facing toward one another, via the gap between the teeth of the rings of teeth. In the annular space around rotor and stator, the gaseous phase is homogeneously incorporated by mixing into the aqueous phase comprising one or more solid phases, under a gage pressure of at least 1 bar.

In another embodiment, the rotor/stator apparatus used can comprise a propeller system with a stator and with a rotor with two or more blade-pairs, where the shear zone is the region between the rotor blade-pairs and the stator, in which a pressure of at least 1 bar is generated, and which is followed by another region between at least one rotor blade-pair and the stator as mixing zone, and where those surfaces facing toward one another of stator and of rotor blade-pairs have preferably been structured. Apparatuses of this type are known by way of example as Reflector® from Lipp Mischtechnik GmbH.

The reaction mixture derived from the incoming stream and from the gaseous phase leaves the rotor/stator apparatus by way of the radial outlet pipe and enters a residence-time zone in which the chemical reaction takes place; the pressure-control valve is downstream of that zone.

That residence-time zone can be a tubular reactor.

It is also possible to form the residence-time zone via a combination of tubular reactor and stirred tank.

An apparatus for isolation of solids from the reaction mixture can be placed downstream of the pressure-control valve.

The incoming stream comprising one or more solid phases dispersed or dissolved in water can also comprise one or more organic phases.

The incoming stream can preferably comprise a magnesium salt dispersed or dissolved in water, and the gaseous phase which is added to the incoming stream can preferably comprise gaseous carbon dioxide.

The inventive process ensures markedly improved solubility of a gaseous phase in an aqueous incoming stream comprising one or more solid phases, and thus ensures improved reaction rate of the reaction mixture accordingly prepared.

The inventive process permits preparation of mixtures derived from gas and water and from one or more solids, using a single, relatively small apparatus, the rotor/stator apparatus. There is therefore no need for any nozzle system or frit system; these systems can easily become blocked by solids.

Ideal, homogeneous, and rapid mixing of the reaction partners is achieved, thus permitting rapid reaction and low reaction times, using relatively small and relatively inexpensive apparatus.

The inventive process can advantageously achieve high conversions, above 90% or even above 95%, in the conduct of chemical reactions in which a gaseous phase is added to an incoming stream comprising one or more solid phases dispersed or dissolved in water.

Further illustration of the invention is provided below using a drawing and inventive examples.

The single FIGURE shows a diagram of a preferred embodiment of a rotor/stator apparatus for use in the inventive process.

The rotor/stator apparatus comprises a rotor 1 and a stator 2 with conical surfaces which face toward one another and which form a shearing gap 3. Upstream of the shearing gap 3 there is an axial feed pipe 5; downstream of the shearing gap 3 there is a radial outlet pipe 6; and there is an annular space 4 surrounding the shearing gap 3. The annular space 4 has an aperture 7 toward the outside.

### INVENTIVE EXAMPLE 1

In a Supraton-Vortex®S 200 apparatus from Buckau-Wolf, an aqueous incoming stream comprising a solid phase is first produced by adding 2.2 m³/h of deionized water by way of the tangential connection to the apparatus and metering 17.6 kg/h of Mg(OH)₂ (Magnefin®H-10 from Martinswerk GmbH) into the apparatus from above by way of a belt weigher. This aqueous incoming stream was sucked into the axial feed pipe of the type of rotor/stator apparatus described in DE 197 20 959 and known by the trade name Supraton®, and equipped with functional chamber elements composed of rings of teeth on the rotor and on the stator.

29 kg/h of gaseous carbon dioxide were metered into the annular space by way of the upper aperture of the annular space, intended as discharge pipe, whereupon ideal mixing with the aqueous incoming stream comprising magnesium hydroxide took place in the annular space.

A gage pressure of 1.5 bar was set in the annular space by means of a pressure-control valve which had been arranged at the end of a residence-time section which followed the radial outlet pipe of the rotor/stator apparatus.

The reaction mixture was passed by way of a radial outlet pipe arranged in the lower part of the annular space, into a residence-time section, formed from a hydraulically operated 0.3 m³ stirred tank, downstream of which there was a DN 200 pipe of length 4 meters, and which was followed by the pressure-control valve.

There was a sampling valve attached downstream of the pressure-control valve.

By way of the sampling valve, a clear solution of Mg(HCO₃)₂ was removed, with 0.10 g/l residual content of undissolved magnesium salts.

Conversion of magnesium hydroxide starting material was therefore 98.8%.

### INVENTIVE EXAMPLE 2

The procedure was as described for inventive example 1, but the residence-time section was modified as follows: no stirred reactor was used, and the UN 200 pipe of length 4 meters was replaced by a DN 150 pipe of length 10 meters.

At the sampling point a clear solution was obtained with 0.9 g/l residual content of undissolved magnesium salts, corresponding to 98.9% conversion of magnesium hydroxide starting material.

### INVENTIVE EXAMPLE 3

The experiment was conducted as in the first inventive example with the following modification of the residence-time zone: no stirred reactor was used, but a DN 200 pipe of length 5 meters was used, and a static mixer for inhibiting solids sedimentation had been installed in the middle of this pipe.

At the sampling point a clear solution of Mg(HCO₃)₂ was obtained, with 0.12 g/l residual content of undissolved magnesium salts, corresponding to 98.5% conversion of magnesium hydroxide.

### COMPARATIVE EXAMPLE 1

The procedure was as in inventive example 1, but the carbon dioxide was not added to the rotor/stator apparatus but to the 0.3 m³ stirred tank, being introduced by bubbling by way of a perforated pipe attached to the base of the stirred tank.

At the sampling point a slightly cloudy solution was obtained with 1.8 g/l residual content of undissolved magnesium salts, corresponding to 77.5% conversion, based on magnesium hydroxide starting material.

### COMPARATIVE EXAMPLE 2

The procedure was as in comparative example 1, but the carbon dioxide was added to the 0.3 m³ stirred tank by way of a frit attached within the base.

At the sampling point a slightly cloudy solution was obtained with 2.1 g/l residual content of undissolved magnesium salts, corresponding to 73.8% conversion of magnesium hydroxide starting material.

1.-10. (canceled)

11. A process for performing a chemical reaction in which a gaseous phase is added to an incoming stream, the process comprising:
adding the incoming stream, which comprises one or more solid phases dispersed or dissolved in water, to a shear zone of an apparatus by way of a feed upstream of the shear zone, the apparatus having a rotor and a stator, with the shear zone being formed by surfaces of the rotor and the stator facing one another, wherein the shear zone is followed by a mixing zone having an aperture toward an outside of the apparatus, and an outlet is downstream of the mixing zone;
generating a gage pressure of at least 1 bar in the shear zone;
incorporating, by mixing, the gaseous phase into the mixing zone, by way of the aperture, and into the incoming stream, under the gage pressure generated in the shear zone, to give a reaction mixture;
feeding the reaction mixture to a residence-time zone via the outlet, wherein a reaction takes place in the residence-time zone; and
controlling pressure in the mixing zone using a pressure-control valve downstream of the residence-time zone.

12. The process according to claim 11, wherein the shear zone is a conical shearing gap, with a gap width being adjustable via axial movement of at least one of the rotor and the stator, the mixing zone is an annular space, the feed is an axial pipe, and the outlet is a radial pipe.

13. The process according to claim 11, wherein the apparatus comprises a functional element which has at least one ring of teeth on at least one of the rotor and the stator, and wherein the shear zone is a gap between the rings of teeth, and the mixing zone is an annular space.

14. The process according to claim 11, wherein the apparatus is a propeller system and the rotor comprises two or more blade-pairs, wherein the shear zone is a region between a first of the blade-pairs and the stator, and the mixing zone is another region between a second of the blade-pairs and the stator.

15. The process according to claim 14, wherein those surfaces facing toward one another of stator and of rotor blade-pairs have preferably been structured.

16. The process according to claim 11, wherein the incoming stream further comprises one or more organic phases.

17. The process according to claim 11, wherein adding the incoming stream includes adding the incoming stream using a powder attachment to the apparatus.

18. The process according to claim 11, wherein the residence-time zone is a tubular reactor.

19. The process according to claim 18, wherein the residence-time zone further comprises a stirred tank.

20. The process according to claim 11, wherein an apparatus for isolation of solids is downstream of the pressure-control valve.

21. The process according to claim 11, wherein the incoming stream comprises a magnesium salt as solid phase, and the gaseous phase comprises carbon dioxide.
